(19) United States
(12) Patent Application Publication
(10) Pub. No.: US 2010/0059183 A1
(43) Pub. Date: Mar. 11, 2010

(54) Wafer taping and detaping machine

(75) Inventors: Gao-Heng Lin, Taichung City (TW); Pzung-Cheng Liou, Taichung City (TW)

Correspondence Address: CHARLES E. BAXLEY, ESQUIRE, 90 JOHN STREET, SUITE 309, NEW YORK, NY, 10038, US

(73) Assignee: Hiwin Mikrosystem Corp.

(21) Appl. No.: 12/283,255

(22) Filed: Sep. 10, 2008

(51) Int. Cl. B32B 41/00

(52) U.S. Cl. 156/351

(57) ABSTRACT

A wafer taping and detaping machine implements a taping roller set and a detaping roller set to conduct an automatic taping and detaping process on a surface of a wafer that is positioned on a wafer mount so as to remove processing particles from the surface of the wafer.

### BACKGROUND OF THE INVENTION

1. Technical Field

The present invention relates to devices for removing processing particles from surfaces of wafers, and more particularly, to a wafer taping and detaping machine that conducts an automatic taping and detaping process on surfaces of wafers so as to remove processing particles from the wafers.

2. Description of Related Art

In the known art, to remove processing particles from surfaces of wafers, a taping and detaping process is manually conducted on the surfaces of the wafers. In a taping step, an adhesive surface of a tape contacts a surface of a wafer and adheres processing particles thereon, and in a successive detaping step, when the adhesive surface of the tape is removed from the surface of the wafer, the processing particles are also taken away from the wafer along with the tape. However, cleaning effect of the conventional manual taping and detaping process is subject to a power exerted to combine a tape and a wafer. Insufficient taping power tends to leave air bubbles between the tape and the wafer. As a result, the surface of the wafer can not be completely adhered by the tape, and causes some of processing particles to be left on the wafer in the detaping step. Yet excessive taping power tends to damage or break the wafer.

### SUMMARY OF THE INVENTION

One objective of the present invention is to provide a wafer taping and detaping machine that conducts an automatic taping and detaping process on surfaces of wafers so as to remove processing particles from the wafers.

Another objective of the present invention is to provide a wafer taping and detaping machine that exerts a proper taping power to combine a tape with a wafer so that a surface of the wafer is entirely adhered by the tape, thereby ensuring processing particles on the surface of the wafer to be completely removed when the tape is torn from the wafer, and promising excellent wafer cleaning effect while the wafer is secured from being damaged because the taping power is properly controlled.

According to the present invention, a wafer taping and detaping machine primarily comprises a wafer mount, a taping roller set and a detaping roller set that are arranged above the wafer mount and linearly reciprocate, and a tape feeder that delivers and retrieves a tape of a tape roll so that the delivered tape passes through the taping roller set and the detaping roller set, thereby allowing the taping roller set and the detaping roller set to clean a wafer by taping and detaping the wafer.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a structural drawing of a wafer taping and detaping machine of the present invention;

FIG. 2 is a perspective view of a wafer mount and an adjusting mechanism of the wafer taping and detaping machine according to the present invention;

FIG. 3 is an assembled cross-sectional view of the wafer mount and the adjusting mechanism of the wafer taping and detaping machine according to the present invention;

FIG. 4 is a perspective assembled view of a taping roller set, a detaping roller set and a linear motor of the wafer taping and detaping machine according to the present invention;

FIG. 5 is a first schematic drawing showing operation of the wafer taping and detaping machine according to the present invention;

FIG. 6 is a second schematic drawing showing operation of the wafer taping and detaping machine according to the present invention;

FIG. 7 is a third schematic drawing showing operation of the wafer taping and detaping machine according to the present invention;

FIG. 8 is a fourth schematic drawing showing operation of the wafer taping and detaping machine according to the present invention; and

FIG. 9 is a fifth schematic drawing showing operation of the wafer taping and detaping machine according to the present invention.

### DETAILED DESCRIPTION OF THE PREFERRED EMBODIMENTS

While a preferred embodiment is provided herein for illustrating the concept of the present invention as described above, it is to be understood that the components in these drawings are made for better explanation and need not to be made in scale. Moreover, in the following description, resemble components are indicated by the same numerals.

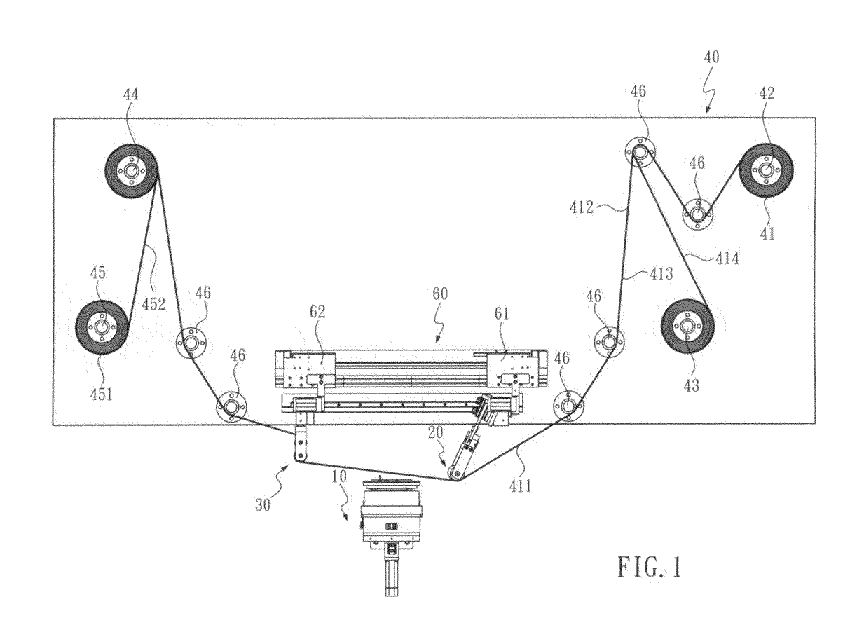

Referring to FIG. 1, 3 and 4, a wafer taping and detaping machine of the present invention primarily comprises a wafer mount 10, a taping roller set 20, a detaping roller set 30, a tape feeder 40, a wafer pressure sensing module 15, a position adjusting mechanism 50, and a taping pressure sensing module 25, whose detailed structures and functions will be given below.

The wafer mount 10 serves to hold a wafer at a taping and detaping position.

The taping roller set 20 and the detaping roller set 30 are arranged above the wafer mount 10 and conduct a linearly reciprocating travel to tape and detape a surface of the wafer held on the wafer mount 10.

The tape feeder 40 delivers and retrieves a tape 411 of a tape roll 41. The delivered tape 411 is led to pass the taping roller set 20 and the detaping roller set 30.

The wafer pressure sensing module 15 is provided in the wafer mount 10 and serves to sense a pressure that the taping roller set 20 applies to the wafer mount 10 and convert the sensed pressure into an electric signal.

The position adjusting mechanism 50 is connected to the wafer mount 10 for receiving the electric signal from the wafer pressure sensing module 15 and vertically adjusting a position of the wafer mount 10 according to the electric signal.

The taping pressure sensing module 25 is provided in the taping roller set 20 to sense a pressure that the tape 411 applies to the taping roller set 20 and then convert the sensed pressure into an electric signal. The tape feeder 40 receives the electric signal and adjusts a tension of the delivered tape 411.

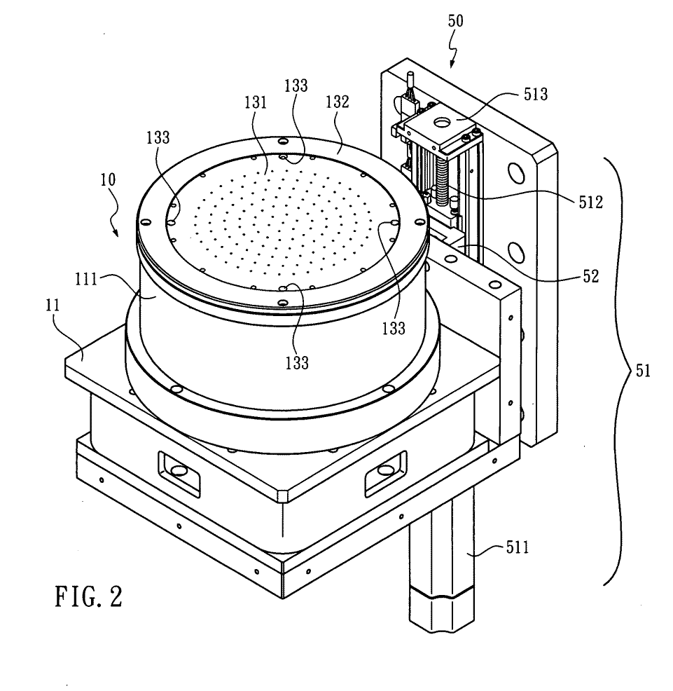

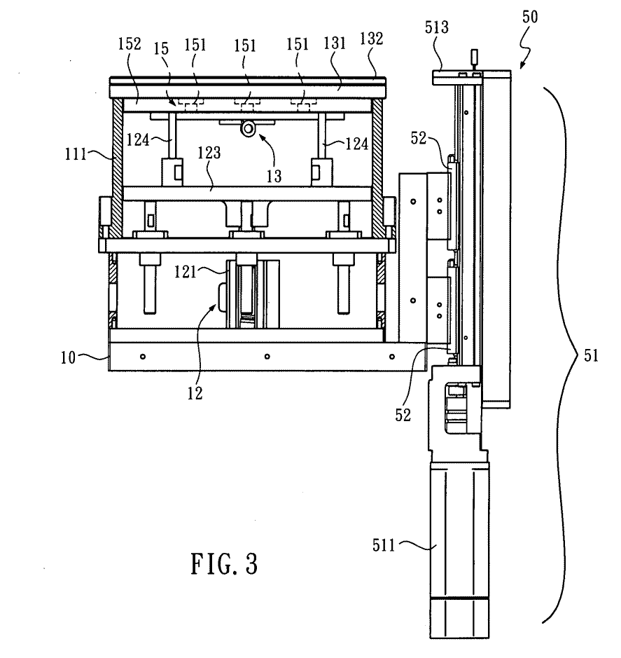

FIGS. 1, 2 and 3 depict the wafer mount 10, the wafer pressure sensing module 15 and the position adjusting mechanism according to one concept of the present embodiment.

The wafer mount 10 has a base 11 wherein a pusher 12 is provided, a vacuum device 13 settled in a seat 111 of the base 11 and having a sucker 131 for holding and positioning a wafer, and an auxiliary ring 132 encircling the sucker 131 and having a thickness equal to a thickness of the wafer. Besides, the pusher 12 includes a power cylinder 121 such as an air cylinder or a hydraulic cylinder that is vertically affixed to the base 11. A driving shaft of the power cylinder 121 is connected with a platform 123 whereon a plurality of pushing rods 124 are erected. When the platform 123 is lifted by the driving shaft of the power cylinder 121, the pushing rods 124 pierce through holes 133 formed on the sucker 131 so as to raise the wafer form the sucker 131.

The wafer pressure sensing module 15 comprises a plurality of load sensors 151 and a saddle 152 for positioning the load sensors 151. The saddle 152 is fixed to a top of the vacuum device 13 while the load sensors 151 contact a bottom surface of the sucker 131. When taping the wafer, the taping roller set 20 moves along an upper surface of the wafer and a tapping pressure the taping roller set 20 applies to the wafer can be sensed by the load sensors 151 through the sucker 131. The sensed tapping pressure is then converted in to an electric signal.

The position adjusting mechanism 50 comprises a vertically fixed linear moving device 51 whose moving seat 52 is connected to the base 11 of the wafer mount 10. The linear moving device 51 has a servomotor 511 driving a screw 512 to rotate in a housing 513 while the moving seat 52 is coupled with the screw 512 in a threaded manner and moves along with the screw 512. The linear moving device 51 controls a number of circles where the screw 512 rotates in either direction according to the electric signal from the load sensors 151 so as to enable the moving seat 52 to drive the wafer mount 10 to rise or descend for a predetermined distance. In other words, when the taping pressure sensed by the load sensors 151 is greater than a preset threshold, the electric signal it converts will direct the position adjusting mechanism 50 to finely bring down the wafer mount 10, or otherwise, finely lift the wafer mount 10. By repeated adjustments, the wafer mount 10 can finally arrive an optimum position where the taping roller set 20 is allowed to exert the proper taping pressure to tape the wafer so that the tape 411 is completely attached to the entire surface of the wafer without any air bubble therebetween and the wafer is protected from getting damaged or broken by improper taping pressure.

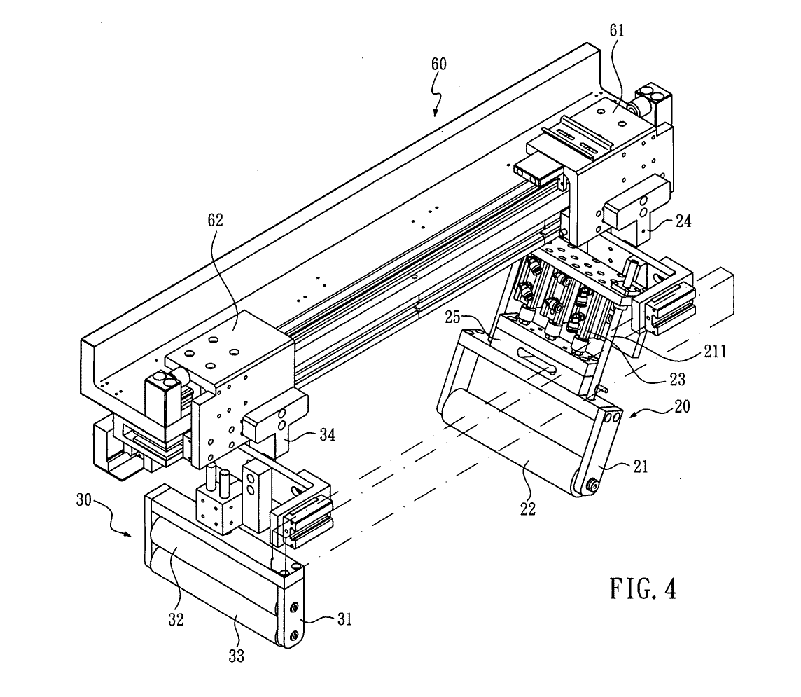

FIGS. 1, 4 and 5 depict the taping roller set 20, the taping pressure sensing module 25, the detaping roller set 30 and the tape feeder 40 according to one concept of the present embodiment.

The taping roller set 20 and the detaping roller set 30 are assembled to two movers 61, 62 of a linear motor 60, respectively, wherein when the two movers 61, 62 move, the taping roller set 20 and the detaping roller set 30 are driven to linearly reciprocate.

The taping roller set 20 has a frame 21 that is assembled with a pressing roller 22. At least one power cylinder 23 such as an air cylinder or a hydraulic cylinder has a body fixed to a connecting seat 24 coupled with the mover 61 and a driving shaft coupled with the frame 21 that has at least two orienting rods 211 piercing through the connecting seat 24 so that the driving shaft enables the frame 21 and the pressing roller 22 to move vertically.

The taping pressure sensing module 25 settled between the frame 21 and the driving shaft may be realized by one or more load sensors. The tape 411 delivered by the tape feeder 40 passes below the pressing roller 22 and the pressing roller 22 contacts the tape 411 at a non-adhesive surface 412 thereof. The pressure the tape 411 applies to the pressing roller 22 is sensed by the load sensors and converted into the electric signal and the tape feeder 40 adjusts the tension of the delivered tape 411 according to the electric signal it receives. In other words, when the pressure detected by the load sensors is greater than a preset threshold, the electric signal converted by the load sensors direct the tape feeder 40 to reduce the tension of the tape 411. Otherwise, the electric signal converted by the load sensors direct the tape feeder 40 to increase the tension of the tape 411. By repeated adjustments, the proper tension of the tape 411 can be achieved.

The detaping roller set 30 has a frame 31 wherein two pressing rollers 32, 33 are assembled in vertical contact with each other. The frame 31 is fixed to a connecting seat 34 coupled with the mover 62. The tape 411 delivered by the tape feeder 40 passes below the pressing roller 22 of the taping roller set 20 and proceeds to wind the lower pressing roller 33 of the detaping roller set 30 and then passes between the pressing rollers 32, 33 and passes above the upper pressing roller 32 and finally rolled up by a tape retrieving roller of the tape feeder 40.

The tape feeder 40 comprises a tape delivering roller 42, a release paper collecting roller 43, the tape retrieving roller 44, a release paper delivering roller 45 that each are driven by a servomotor, and a plurality of idle rollers 46. The tape roll 41 is mounted on the tape delivering roller 42 for delivering the tape 411 that is later retrieved by the tape retrieving roller 44. The delivered tape 411 presents the proper tension on the strength of the idle rollers 46. The release paper collecting roller 43 departs a release paper 414 from an adhesive surface 413 of the tape 411 and collects the release paper 414 so that when the tape 411 passes below the pressing roller 22 of the taping roller set 20 with its adhesive surface 413 downward, the adhesive surface 413 can adhere to the upper surface of the wafer under the pressure of the pressing roller 22. The release paper delivering roller 45 holds another release paper roll 451 for delivering a release paper 452 so that when the tape 411 is retrieved by the tape retrieving roller 44, the release paper 452 is combined with the adhesive surface 413.

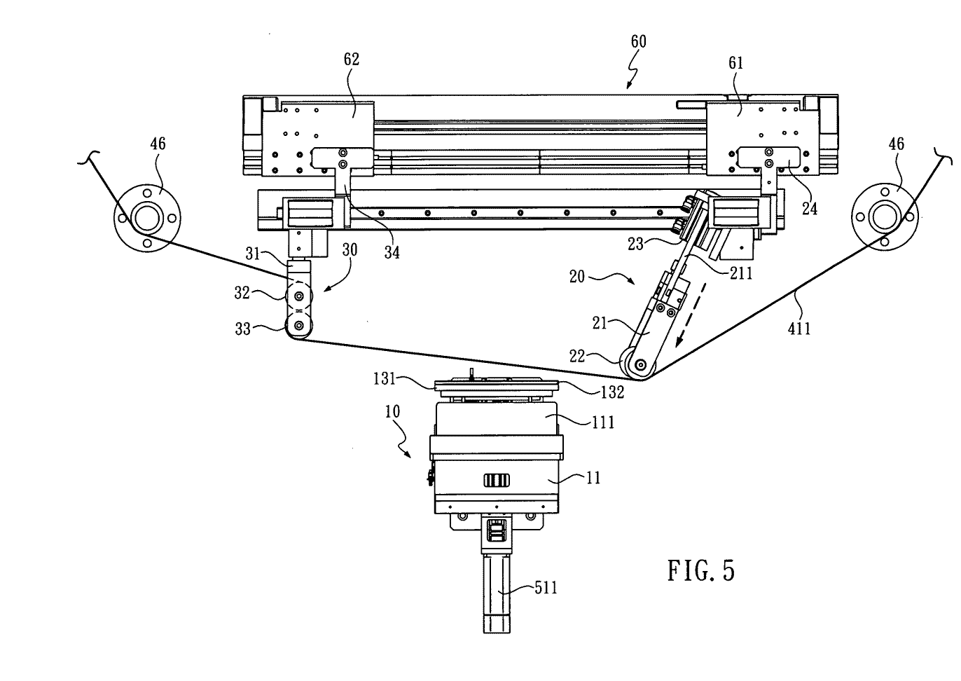

FIGS. 5 to 8 are provided to illustrate an automatic taping and detaping process conducted by the wafer taping and detaping machine according to the present invention.

Referring to FIG. 5, the tape 411 passes by the pressing roller 22 of the taping roller set 20 and winds the two pressing rollers 32, 33 of the detaping roller set 30. The driving shaft 23 of the taping roller set 20 moves the frame 21 and the pressing roller 22 downward to abut the tape 411.

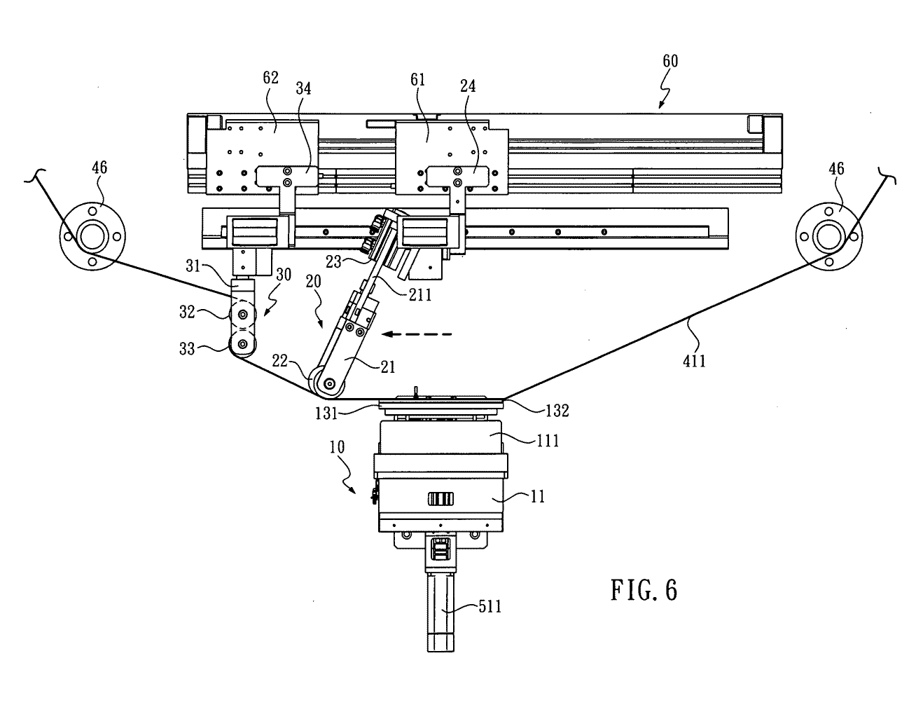

In FIG. 6, the taping roller set 20 is driven by the mover 61 of the linear motor 60 to move toward the detaping roller set 30. The pressing roller 22 presses the upper surface of the wafer with the proper taping pressure so as to adhere the adhesive surface 413 of the tape 411 onto the upper surface of the wafer. Thereby, the tape 411 is completely attached to the entire surface of the wafer without any air bubble therebetween and the wafer is protected from getting damaged or broken by excessive taping pressure.

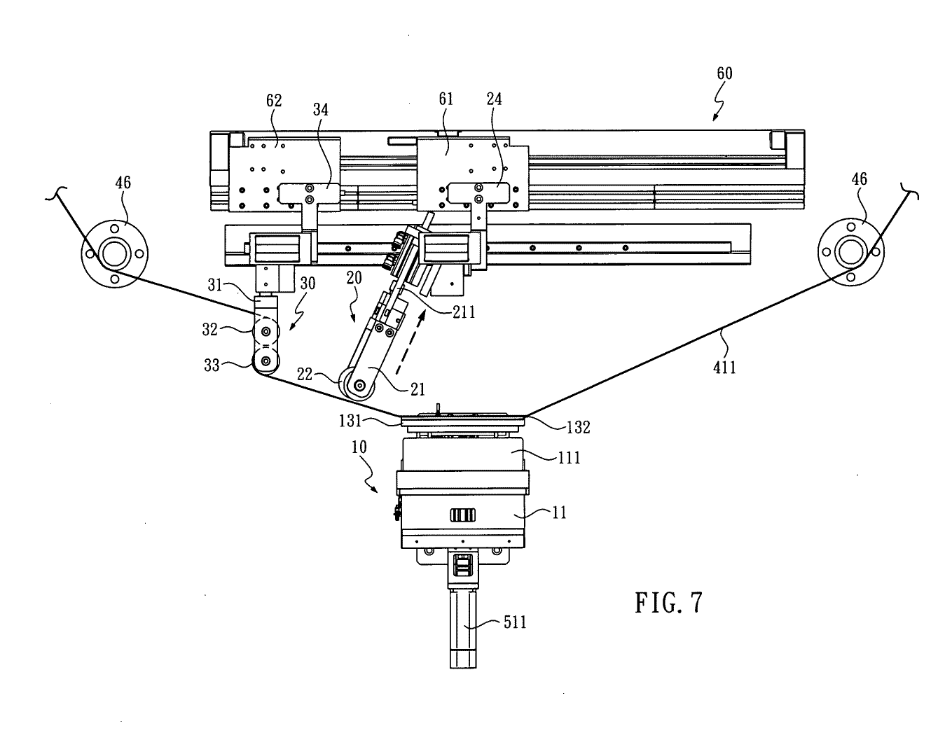

According to FIG. 7, after the pressing roller 22 of the taping roller set 20 tapes the waver, the driving shaft 23 lifts the frame 21 and the pressing roller 22 from the tape 411.

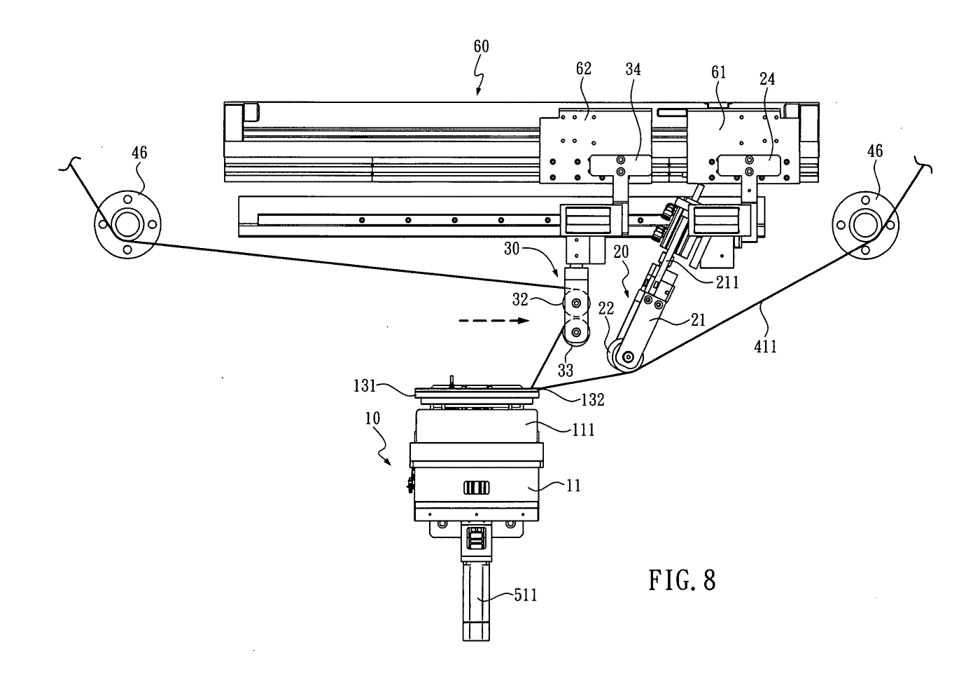

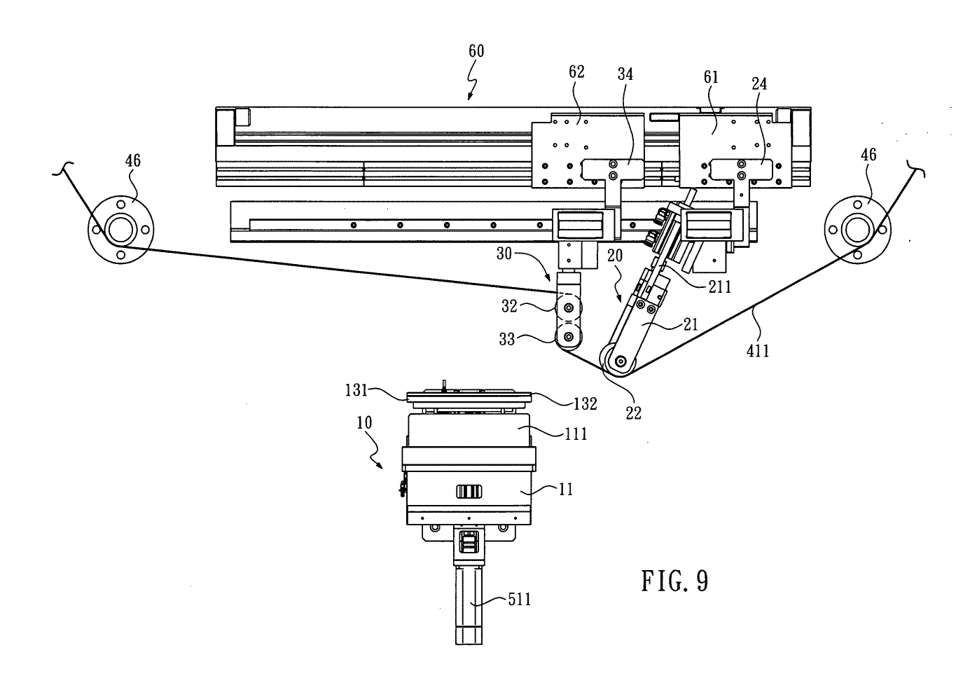

In FIGS. 8 and 9, the taping roller set 20 and the detaping roller set 30 are driven by the two movers 61, 62 of the liner motor 60 to move toward the initial position of the taping roller set 20 so that the taping roller set 20 returns to its initial position and the detaping roller set 30 removes the tape 411 from the upper surface of the wafer. Consequently, processing particles attaching to the adhesive surface 413 are taken away from the upper surface of the wafer along with the tape 411, thereby cleaning the wafer.

Referring back to FIG. 5, the detaping roller set 30 then returns to its initial position and the automatic taping and detaping process is accomplished.

Although the particular embodiment of the invention has been described in detail for purposes of illustration, it will be understood by one of ordinary skill in the art that numerous variations will be possible to the disclosed embodiment without going outside the scope of the invention as disclosed in the claims.

What is claimed is:

1. A wafer taping and detaping machine, comprising:
a wafer mount, holding a wafer at a taping and detaping position;
a taping roller set and a detaping roller set, arranged above the wafer mount and linearly reciprocating;
a tape feeder, delivering and retrieving a tape of a tape roll, wherein the delivered tape is led to pass the taping roller set and the detaping roller set;
a wafer pressure sensing module, provided in the wafer mount for sensing a pressure that the taping roller set applies to the wafer and converting the sensed pressure into an electric signal;
a position adjusting mechanism, connected to the wafer mount for receiving the electric signal from the wafer pressure sensing module and vertically adjusting a position of the wafer mount according to the electric signal; and
a taping pressure sensing module, provided in the taping roller set for sensing a pressure that the tape applies to the taping roller set and converting the sensed pressure into an electric signal, wherein the tape feeder receives the electric signal and adjusts a tension of the delivered tape.

2. The wafer taping and detaping machine of claim 1, wherein the wafer mount has a base wherein a pusher is provided, a vacuum device settled in a seat of the base and having a sucker for holding and positioning the wafer at the taping and detaping position.

3. The wafer taping and detaping machine of claim 2, wherein an auxiliary ring encircles the sucker.

4. The wafer taping and detaping machine of claim 2, wherein the pusher includes a power cylinder that is vertically affixed to the base and a driving shaft of the power cylinder is connected with a platform whereon a plurality of pushing rods are erected so that when the platform is lifted by the driving shaft of the power cylinder, the pushing rods pierce through holes formed on the sucker.

5. The wafer taping and detaping machine of claim 2, wherein the wafer pressure sensing module comprises a plurality of load sensors and a saddle for positioning the load sensors, in which the saddle is fixed to a top of the vacuum device and the load sensors contact a bottom surface of the sucker.

6. The wafer taping and detaping machine of claim 1, wherein the position adjusting mechanism comprises a vertically fixed linear moving device that has a moving seat connected to the wafer mount.

7. The wafer taping and detaping machine of claim 6, wherein the linear moving device has a servomotor driving a screw to rotate in a housing while the moving seat is coupled with the screw by a thread means and moves along with the screw.

8. The wafer taping and detaping machine of claim 1, wherein the taping roller set and the detaping roller set are assembled to two movers of a linear motor, respectively.

9. The wafer taping and detaping machine of claim 8, wherein the taping roller set has a frame that is assembled with a pressing roller and at least one power cylinder having body fixed to a connecting seat coupled with the mover and a driving shaft coupled with the frame.

10. The wafer taping and detaping machine of claim 9, wherein the frame has at least two orienting rods piercing through the connecting seat.

11. The wafer taping and detaping machine of claim 8, wherein the detaping roller set has a frame wherein two pressing rollers are assembled in vertical contact with each other and the frame is fixed to a connecting seat coupled with the mover.

12. The wafer taping and detaping machine of claim 1, wherein the tape feeder comprises a tape delivering roller, and a tape retrieving roller that are each driven by a servomotor, and a plurality of idle rollers, in which the tape roll is mounted on the tape delivering roller for delivering the tape that is later retrieved by the tape retrieving roller.

13. The wafer taping and detaping machine of claim 12, further comprising a release paper collecting roller departing a release paper from an adhesive surface of the tape before the tape passes by the taping roller set.

14. The wafer taping and detaping machine of claim 13, further comprising a release paper delivering roller combining a release paper of a release paper roll with the adhesive surface of the tape when the tape is retrieved by the tape retrieving roller.
